(19) United States
(12) Patent Application Publication
(10) Pub. No.: US 2015/0022211 A1
(43) Pub. Date: Jan. 22, 2015

(54) DETECTION CIRCUIT FOR DISPLAY PANEL

(71) Applicant: SHENZHEN CHINA STAR OPTOELECTRONICS TECHNOLOGY CO., LTD., Shenzhen, Guangdong (CN)

(72) Inventors: Peng Du, Shenzhen (CN); Je-Hao Hsu, Shenzhen (CN); Ming-hung Shih, Shenzhen (CN)

(21) Appl. No.: 14/241,416

(22) PCT Filed: Jan. 17, 2014
(86) PCT No.: PCT/CN2014/070829

§ 371 Date: Feb. 26, 2014

(30) Foreign Application Priority Data
Jul. 19, 2013 (CN) 201310306547.X

(51) Int. Cl. G09G 3/00

(52) U.S. Cl. CPC G09G 3/006
USPC 324/414

(57) ABSTRACT

The present disclosure provides a detection circuit for a display panel, comprising: a shorting bar, with connection lines for introducing a test signal or a control signal arranged thereon; a transistor array, the gates of which are connected to the connection lines for introducing the control signal, wherein the connection lines for introducing the test signal are connected with the data lines or the scanning lines of the display panel via the sources and the drains of transistors, under the control signal, and a component, arranged between the gates of the transistor array and the shorting bar, for further reducing or increasing a voltage or current of the gates so that the transistor array can be cut off reliably when the control signal is a signal enabling the transistor array to be cut off. The detection circuit can further reduce the channel length of the thus being advantageous for the design of the narrow frame.

### FIELD OF THE INVENTION

The present disclosure relates to the field of display technologies, and particularly relates to a detection circuit for a display panel.

### BACKGROUND OF THE INVENTION

In the process of manufacturing a thin film transistor-liquid crystal display (TFT-LCD) panel, specifically in the phases of manufacturing an array and a cell, the yield of the liquid crystal panel is generally monitored through a test such as light-on testing. Connection between a test circuit and circuits on a display area can be removed out or laser out after a test. However, under some circumstances, the removal out or laser out is not very convenient. If the test circuit is reserved, leakage currents exist between the sources and the drains of components such as TFT (thin film transistor) switches in the test circuit, which interfere with the data lines and gate lines of the display area. In one case, for preventing the leakage currents of the TFT switches in a cut-off state, the channel lengths of the TFT switches can be made longer than before, for example, about 10 microns. But by doing so, it is disadvantageous for the design of a narrow frame.

Therefore, there is a need of a panel detection circuit capable of effectively preventing the test circuit from interfere with a display panel during the operation of the display panel.

### SUMMARY OF THE INVENTION

One aim of the present disclosure is to provide a panel detection circuit capable of effectively preventing the test circuit from interfere with a display panel during the operation of the display panel.

In order to solve the above-mentioned technical problems, the present disclosure provides a detection circuit for a display panel, wherein the circuit comprises:

a shorting bar, with connection lines for introducing a test signal or a control signal arranged thereon; and

a transistor array, the gates of which are connected to the connection lines for introducing the control signal, wherein, the connection lines for introducing the test signal are connected with data lines or scanning lines of the display panel via the sources and the drains of transistors, under the control signal,

wherein a component is arranged between the gates of the transistor array and the shorting bar, for further reducing a voltage on the gates so that the transistor array can be cut off reliably when the control signal is a signal enabling the transistor array to be cut off.

In an embodiment of the present disclosure, the transistor array is a TFT array or an MOSFET (metal oxide semiconductor field effect transistor) array.

In an embodiment of the present disclosure, the component is a diode, wherein the cathode of the diode is connected with the gates of the transistor array, and the anode of the diode is connected to the connection lines for introducing the control signal.

In an embodiment of the present disclosure, the component is another transistor, the gate and the source of which are connected with each other, so as to connect to the connection lines for introducing the control signal together, and the drain of which is connected with the gates of the transistor array.

In an embodiment of the present disclosure, the component is another transistor, the gate and the source of which are connected, so as to connect to the connection lines for introducing the test signal, and the drain of which is connected with the gates of the transistor array.

In an embodiment of the present disclosure, the transistor is a TFT or an MOSFET.

In an embodiment of the present disclosure, the channel length of the TFT is 3-5 microns.

Compared with the prior art, the present disclosure brings the following beneficial effects: (1) by arranging the component between the gates of the transistor array and the shorting bar for further reducing the voltage on the gates, the whole transistor array can be reliably cut off when applying a low-level signal to control the transistor array, so as to reduce the leakage currents; (2) by sharing the connection lines for introducing a control signal and the test lines, it is possible to prevent the suspension of the detection circuit from interfering the normal operation of the display panel; and (3) the detection circuit of the present disclosure can further reduce the channel length of the TFT, thus being advantageous for the design of the narrow frame.

Other features and advantages of the present disclosure will be illustrated in the following description, and are partially obvious from the description or understood through implementing the present disclosure. The objectives and other advantages of the present disclosure may be realized and obtained through the structures specified in the description, claims, and accompanying drawings.

### BRIEF DESCRIPTION OF THE DRAWINGS

The accompanying drawings are provided for a further understanding of the present disclosure, constitute a part of the description, and are used for interpreting the present disclosure together with the embodiments of the present disclosure, rather than limiting the present disclosure. In the accompanying drawings:

FIG. 1 is a schematic diagram of a detection circuit according to the present disclosure;

FIG. 2 is a schematic diagram showing a leakage current between two digital switches;

FIG. 3 is a schematic diagram of an improved equivalent circuit according to the present disclosure;

FIG. 4 is a schematic diagram of a detection circuit according to an embodiment of the present disclosure;

FIG. 5 is a schematic diagram of another improved equivalent circuit according to the present disclosure; and

FIG. 6 is a schematic diagram of a detection circuit according to another embodiment of the present disclosure.

### DETAILED DESCRIPTION OF THE EMBODIMENTS

The embodiments of the present disclosure will be illustrated in detail in conjunction with the accompanying drawings and embodiments, and thus how to use technical means to solve the technical problems and the implementation process of achieving the technical effects may be fully understood and accordingly implemented. It should be noted that as long as conflicts are avoided, all embodiments in the present disclosure and all features in all the embodiments may be combined together, and the formed technical solutions are within the scope of the present disclosure.

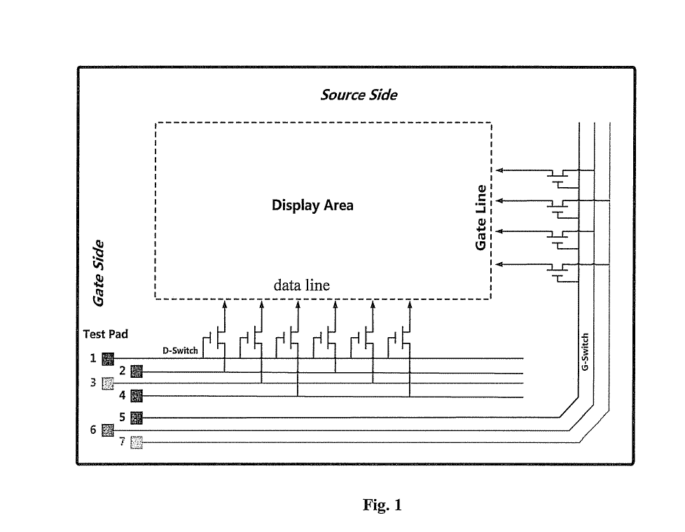

FIG. 1 shows a schematic diagram of a detection circuit. In FIG. 1, test pads 1-7 each are connected to the data lines and the scanning lines of the display panel via a digital switch array (for example, a TFT switch array) and wires (or connection lines) on a shorting bar. The digital switch array is not limited to the TFT switch array, and other controllable digital switch arrays such as a transistor array can also be applied to the present disclosure. In the technical field of LCD (liquid crystal display), TFT switch transistors are preferably used as the digital switches.

In addition, the connection lines on the shorting bar comprise control connection lines respectively connected to the test pad 1 and the test pad 5, and test connection lines respectively connected with the test pads 2-4, the test pad 6 and the test pad 7. The test pad 1 and the test pad 5 are connected to the gates of the TFT switches through the control connection lines. The test pads 2-4, the test pad 6 and the test pad 7 are connected to the drains of the TFT switches through the test connection lines. The sources of the TFT switches are connected with the data lines or the scanning lines arranged on the display area. Different numbers of TFT switches and different numbers of the test pads can be distributed on the data lines or the scanning lines according to actual conditions, so as to perform a light-on test. For example, the test pads 2-4 can be connected to the data lines via 6 TFT switches, and the test pad 6 and the test pad 7 can be connected to the scanning lines (gate lines) via 4 TFT switches.

During detection, a high-level signal is input to the test pad 1 and the test pad 5, thus controlling the TFT switches to be turned on. Therefore, a test on the display panel can be performed only by respectively applying a signal required for the detection on the test pads 2-4, the test pad 6 and the test pad 7.

During using the display panel after being manufactured, a low-level signal is input to the test pad 1 and the test pad 5 to cause the TFT switches to be cut off, thus further breaking connection between the shorting bar and the data lines or the scanning lines (gate lines).

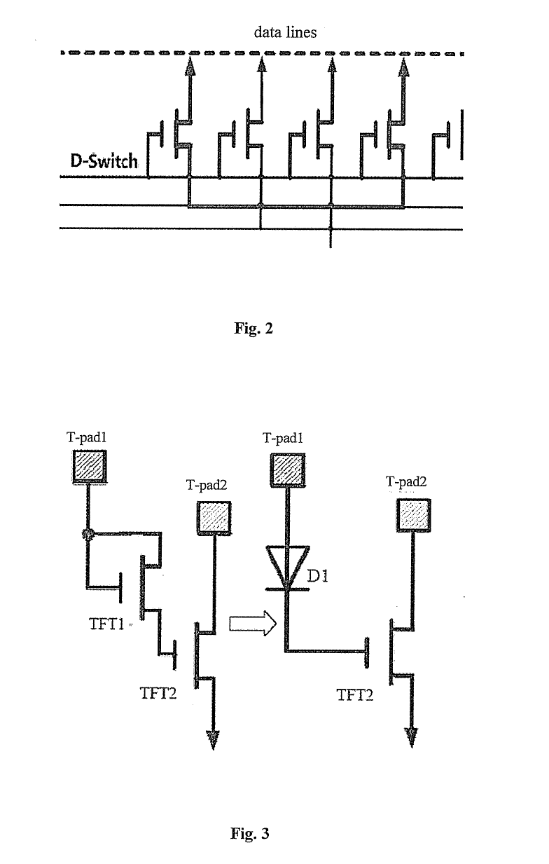

According to such design, in order for saving the time, there is no need for laser-cutting connections among the shorting bar, the data lines and the scanning lines after detecting the display panel,. However, during the working of the display panel, the TFT switches are in a negative bias state for a long time, and no test signal exists on the test pads 2-4, the test pad 6, and the test pad 7, which results in that the drain sides of the TFT switches are always in suspending state. The suspending state will generate a fluctuation of voltages under some circumstances, which may cause that the sources and the drains of the TFT switches from leakage channels on the condition of reverse cut-off, and thereby generate leakage currents. One circumstance of the leakage currents is indicated by a bold line in FIG. 2. To some extent, the leakage currents will indirectly cause the interference of an external signal with the data lines or the scanning lines via the shorting bar, thus the display quality of the panel is influenced.

In order to avoid occurring the leakage currents of the TFT switches in a cut-off state, the channel lengths of the TFT switches can be formed to be large, for example, about 10 microns. However, in doing so, it is hard to manufacture a product with a design in narrow frame.

Therefore, the present disclosure further provides a circuit for testing a display panel, which comprises a shorting bar and a transistor array. As shown above, connection lines for introducing a test signal or a control signal are distributed on the shorting bar. The connection lines for introducing the test signal are connected with the data lines or the scanning lines of the display panel via the sources and the drains of transistors under the control signal.

According to the present disclosure, a component is further arranged between the gates of the transistor array and the shorting bar. In the case that the control signal is a signal causing the transistor array to be cut off, the component is used for further reducing or increasing a voltage on the gates, thus reliably cutting off the transistor array.

As mentioned above, the transistor array may be a TFT switch array, a triode, or an enhanced MOS (metal oxide semiconductor) transistor array. In the case that the transistor array is a TFT switch array, the control signal is a low-level signal. With regard to a triode and an enhanced MOS transistor, the control signals are corresponding current and voltage signals causing the triode and the enhanced MOS transistor to be cut off.

In actual applications, the component may be a diode or another transistor. In the case that the component is a diode, the cathode of the diode is connected with the gates of the transistor array, and the anode of the diode is connected to the test pads for introducing a control signal. In the case that the component is a transistor, the gate and the source of the transistor are connected with each other, thus being connected to the connection lines for introducing the control signal together. The drain of the transistor is connected with the gates of the transistor array.

FIG. 3 is a schematic diagram of an improved equivalent circuit according to the above-mentioned manner in which the leakage currents of the transistor array are avoided. In the diagram, another TFT switch, indicated by TFT2, is added between the gate of the digital switch indicated by TFT2 in FIG. 3 and the test pad 1.

Alternatively, in a preferred manner, both of another transistor and the transistor array may be TFTs or MOSFETs.

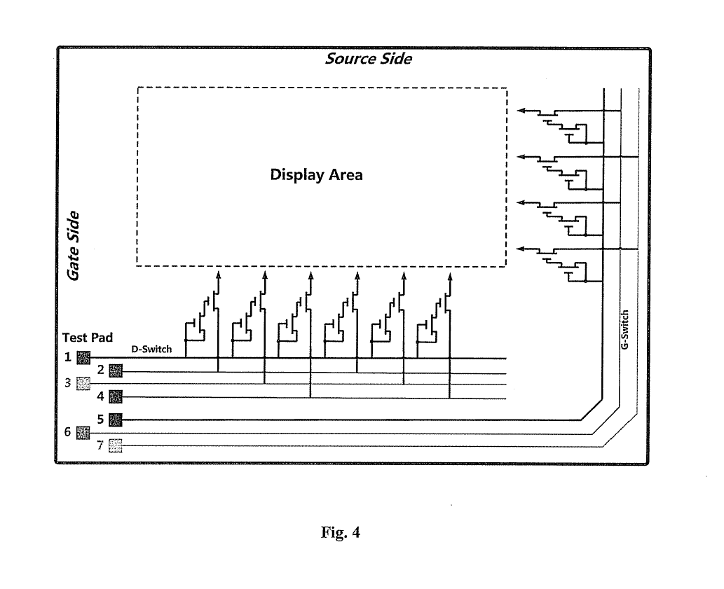

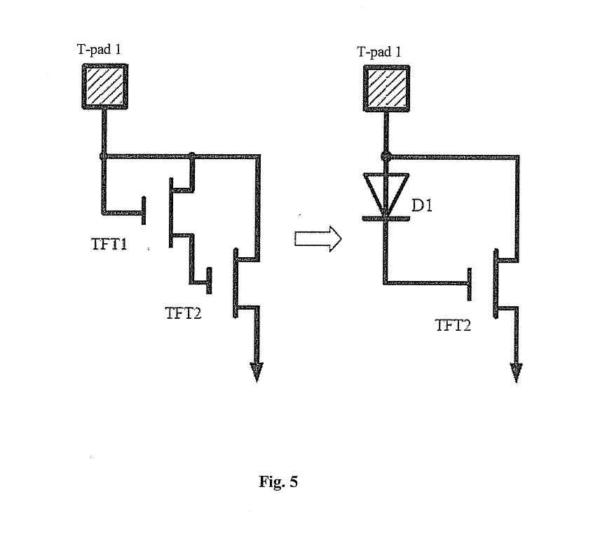

FIG. 4 shows a schematic diagram of a detection circuit applying the above-mentioned improvement to circuits of a display area. The difference between FIG. 4 and FIG. 1 is that another digital switch TFT2 is placed between the gate line of a switch array TFT1 and the wires of the shorting bar. The source and the gate of the digital switch TFT2 are connected, and the drain is connected with the gate of the digital switch TFT1, for controlling the TFT1 to be reliably cut off.

The detection circuit shown in FIG. 4 is capable of effectively avoiding a leakage current between the source and the drain of the switch array TFT1.

As shown in FIG. 5, it is another equivalent circuit, wherein the gate and the source of the digital switch transistor TFT1 are connected, thus being connected to the test pads introduced with a test signal, and the drain of the another transistor is connected with the gates of the transistor array. In this circumstance, there is no need to arrange control lines additionally on the shorting bar, and thus there is no need for a special control signal.

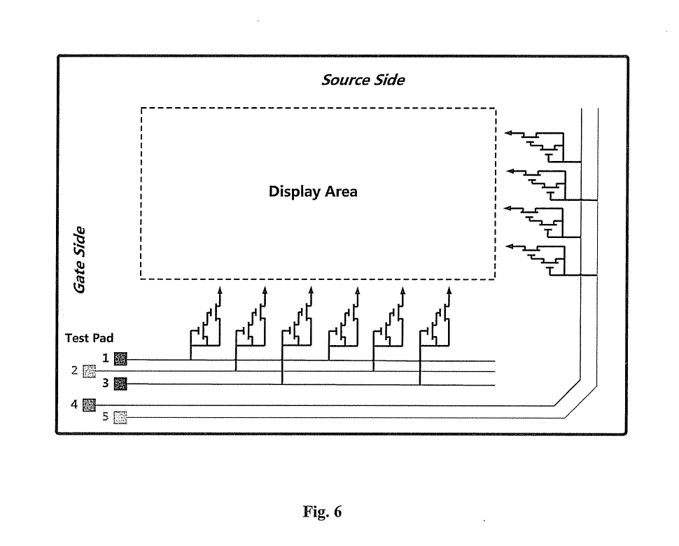

As shown in FIG. 6, during a test, a voltage on a test circuit is high enough to turn on the TFT1 and the TFT2, and a test signal is introduced onto the data lines and the scanning lines in the display panel via the sources and the drains respectively. Where there is no test, a low-level signal is applied to all test pads, which can avoid that a part of circuits is suspending. In this case, the switch array TFT2 can be reliably cut off without generating leakage currents.

In the above design, the channel length of the switch TFT can be short (3-5 microns), and the channel length of the switch TFT with the traditional design is generally about 10 microns. Due to the novel design, space can be saved, thus being very advantageous for the present popular design of a narrow frame.

Although the embodiments are described above, the foregoing are merely the embodiments for facilitating the understanding of the present disclosure, rather than limiting the present disclosure. Any changes or alternatives conceived by the skilled ones in the art after reading the content disclosed herein will fall within the scope of the present disclosure. Accordingly, the scope of the present disclosure will be defined in the accompanying claims.

What is claimed:

1. A detection circuit for a display panel, comprising:
a shorting bar, with connection lines for introducing a test signal or a control signal arranged thereon;
a transistor array, the gates of which are connected to the connection lines for introducing the control signal, wherein the connection lines for introducing the test signal are connected with data lines or scanning lines of the display panel via the sources and the drains of transistors, under the control signal, and
a component, arranged between the gates of the transistor array and the shorting bar, for further reducing or increasing a voltage or a current of the gates so that the transistor array can be cut off reliably when the control signal is a signal enabling the transistor array to be cut off.

2. The circuit as recited in claim 1, wherein the transistor array is a TFT array or an MOSFET array.

3. The circuit as recited in claim 1, wherein the component is a diode, the cathode of which is connected with the gates of the transistor array, and the anode of which is connected to the connection lines for introducing the control signal.

4. The circuit as recited in claim 1, wherein the component is another transistor, the gate and the source of which are connected with each other, so as to connect to the connection lines for introducing the control signal together, and the drain of which is connected with the gates of the transistor array.

5. The circuit as recited in claim 1, wherein the component is another transistor, the gate and the source of which are connected with each other, so as to connect to the connection lines for introducing the test signal together, and the drain of which is connected with the gates of the transistor array.

6. The circuit as recited in claim 5, wherein the transistor is a TFT or an MOSFET.

7. The circuit as recited in claim 6, wherein the channel length of the TFT is 3-5 microns.

8. The circuit as recited in claim 2, wherein the component is a diode, the cathode of which is connected with the gates of the transistor array, and the anode of which is connected to the connection lines for introducing the control signal.

9. The circuit as recited in claim 2, wherein the component is another transistor, the gate and the source of which are connected with each other, so as to connect to the connection lines for introducing the test signal together, and the drain of which is connected with the gates of the transistor array.

10. The circuit as recited in claim 2, wherein the component is another transistor, the gate and the source of which are connected with each other, so as to connect to the connection lines for introducing the test signal together, and the drain of which is connected with the gates of the transistor array.
